(19) United States
(12) Patent Application Publication
(10) Pub. No.: US 2017/0099133 A1
(43) Pub. Date: Apr. 6, 2017

(54) METHOD AND SYSTEM FOR PRIVACY-FRIENDLY LOCATION-BASED ADVERTISING

(71) Applicant: Pitney Bowes Inc., Danbury, CT (US)

(72) Inventors: QIUJU GU, Trumbull, CT (US); Michael P. Swenson, Brookfield, CT (US); Femi Olumofin, Cupertino, CA (US); John G. Desmond, Fairfield, CT (US)

(73) Assignee: PITNEY BOWES INC., Danbury, CT (US)

(21) Appl. No.: 14/872,199

(22) Filed: Oct. 1, 2015

(51) Int. Cl. H04L 9/00; H04L 9/08; H04W 4/02

(52) U.S. Cl. CPC H04L 9/008; H04W 4/023; H04L 9/0869; H04L 2209/24

(57) ABSTRACT

A system and method that enables a LBS provider to provide a location-based marketplace for third-party businesses to market or advertise location- and/or need-based offers to users while keeping the users' information confidential from both the LBS provider and the third party businesses is provided. While the LBS provider is able to identify a user, it cannot learn his/her needs. The third party businesses can learn the user needs, but not the identity of the users with the need. A business can compare its target location for a marketing/advertising campaign to the user's location, such that it can learn when a user is currently at a target location. However, the business will fail to learn the identity of a user in the target location, or any information about the user's current location when outside of the target location.

### FIELD OF THE INVENTION

The present invention relates to marketing offers and personal information privacy, and in particular to a method and system for a location-based service provider to provide a location-based marketplace for third-party businesses to market or advertise location and/or need based offers to users while maintaining the privacy of the user's information.

### BACKGROUND OF THE INVENTION

In today's highly competitive business world, advertising to customers, both potential and previous, is a necessity. Businesses are always looking for ways to increase revenue, and increasing its sales to customers through advertising plays a large part in many business's plans for growth. Advertising has shown to be an effective method to inform, persuade or remind target buyers of the business's goods, services or goodwill, with the ultimate goal being that an advertisement will result in the sale of the goods or services. Studies have confirmed that the more that an advertisement can be made relevant and timely for a particular intended recipient, the more likely that it is to be successful. Location-based service (LBS) providers allow a business to provide a location-based service, e.g., coupon, advertisements, brochures, information, etc., to potential customers that are both timely and relevant. For example, a smart-phone (or other networked mobile device) user may register with the LBS provider to be provided with a service when the user is in the proximity of a selected business. This typically provides both the business and the LBS provider with the identification of the user, and also allows both the business and the LBS provider to determine both the location and needs of the user. Typically this is done by the user disclosing her needs and location to the LBS provider, and the LBS provider aggregating this information and using it to solicit offers from third party businesses.

A problem with the conventional method for providing advertisements/services as described above is that both the business and the LBS provider obtain knowledge of the user's identification, location and needs. This is in direct contrast to the desires of today's mobile savvy consumers, who prefer to utilize such services while maintaining their location and personal information confidential.

### SUMMARY OF THE INVENTION

The present invention alleviates the problems described above by enabling a LBS provider to provide a location-based marketplace for third-party businesses to market or advertise location- and/or need-based offers to users while keeping the users' information confidential from both the LBS provider and the third party businesses. While the LBS provider is able to identify a user, it cannot learn his/her needs. The third party businesses can learn the user needs, but not the identity of the users with the need.

In accordance with embodiments of the present invention, cryptographic techniques relating to the class of additive homomorphic cryptosystems and private information retrieval (PIR) are leveraged. The cryptosystem allows a business to compare its target location for marketing/advertising campaign to the user's location, such that it can learn when a user is currently at a target location. However, the business will fail to learn the identity of a user in the target location, or any information about the users current location when outside of the target location. PIR enables a user to retrieve a record from a database, without the LBS provider being able to learn any information about which particular record the user has retrieved. PIR is utilized to retrieve public key information of businesses doing advertising/marketing campaigns in a location that is of interest to the user, and to retrieve offers made to the user in a manner that hides which offer was retrieved from the LBS provider.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of illustrating a system according to embodiments of the present invention; and

FIGS. 2 and 3 are flowcharts illustrating operation of the system of FIG. 1 according to embodiments of the present invention.

### DETAILED DESCRIPTION OF THE PRESENT INVENTION

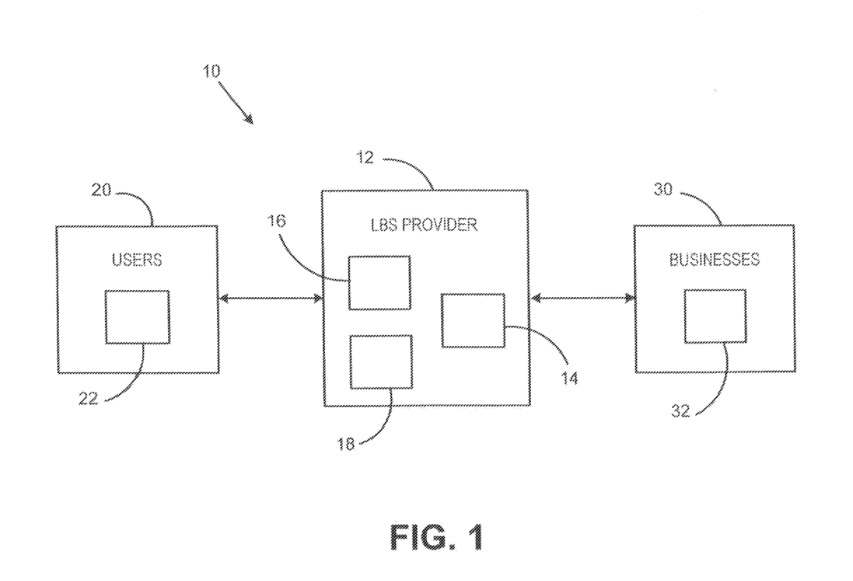

In describing the present invention, reference is made to the drawings, wherein there is seen in FIG. 1 in block diagram form a system 10 that can be used to implement the method described herein according to embodiments of the present invention. System 10 includes a server 12 operated by a LBS provider, which may be, for example, a cloud service provider. Server 12 may be a mainframe or the like that includes at least one processing device 16. Server 12 may be specially constructed for the required purposes, or it may comprise a general purpose computer selectively activated or reconfigured by a computer program (described further below) stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, which are executable by the processing device 16. One of ordinary skill in the art would be familiar with the general components of a computing system upon which the method of the present invention may be performed. A database 14 is coupled to the processor 16 for storing of information and data. A network interface 18 is provided to allow the server 12 to communicate with other devices via any suitable network.

Such other devices can include one or more devices operated by a user 20, e.g., user mobile device 22. User mobile device 22 comprises a processing device and can include personal computers, tablets, smartphones or any other type of electronic device that has network capability and can allow a consumer to access other devices via any suitable network. It should be understood that there is no limit to the number of devices and/or users of such devices. The users 20 are interested in receiving free products, discounts, coupons or similar offers relevant to their real time needs and location, and yet they want to keep their needs and location information private and make their identity not linkable by the business to the needs they express. System 10 also includes one or more businesses 30 that operate a computing device 32, which can be similar to the user mobile device 22 or server 12 described above. A business 30 can be any type of service provider, merchant or third party acting on behalf of such entities that is interested in doing location-based marketing/advertising campaigns. They want a high response rate for their campaigns and they anticipate that learning the real time needs of users would help make their campaign more successful. It should be understood that there is no limit to the number of businesses. The present invention, as described below, helps businesses 30 target users 20 by their location and needs, and helps users 20 keep their information private even as they benefit from offers relevant to their real time needs and location.

The present solution utilizes a spatial grid structure having a plurality of cells to quantize and index locations of users 20. A grid can be defined in many ways, provided that each location with a given latitude/longitude is associated with a unique cell of the grid. For example, the United States can be divided in many 100×100 meter cells that are each associated with a unique identifier. The longitude and latitude of a users current location will determine the grid used to situate the user. It should be understood, of course, that the cell size need not be limited to the example provided above, and could be any size as desired. In fact, any spatial grids, regions and range-based subdivision should suffice to quantize location information.

A resource-efficient program runs in the background on the user's mobile device 22, which provides a user interface for interaction. This program collects information about the user's location from the device's GPS, through a WiFi positioning system, cell tower triangulation, or any other known means for determining position. The program also collects information about what the user 20 needs, either from the user making the input directly or by the program reading such needs from sensors connected (wirelessly, e.g., via Bluetooth) to the mobile device 22. Examples of the kinds of information that may be collected and possible uses are: (i) Targeting based on information about the user's current location: Alice is a tourist in NYC walking along Broadway on a Saturday evening and may be interested in obtaining promo tickets for shows. Ticketmaster and similar businesses in the event marketing and entertainment space may be interested in offering their last few tickets at promo rates for shows holding that evening. (ii) Targeting using information about what the user needs right now: Bob is going to be serving pizza to a dozen friends coming over this evening, and he is wondering if he could get promotions/offers from pizza stores. Bob inputs pizza as a need to the program. (iii) Targeting based on a combination of what and when: Trent's car is due for oil change, and he needs coupons redeemable today at any of the nearby oil change centers.

As part of the setup for system 10, an additively homomorphic or fully homomorphic cryptosystem, such as Elgamal's, Pallier's, Damgård-Jurik's, Gentry's etc., is utilized, with the following high-level parameters. A public key homomorphic encryption scheme is a public key encryption scheme that allows certain operations on the encrypted information without the knowledge of the private key. The present invention utilizes a homomorphic encryption scheme that has the following property: Given encryptions E(m1) and E(m2) of two messages m1 and m2 respectively, E(m1−m2) can be efficiently computed without the knowledge of the secret (private) key. The key generation, encryption and decryption algorithms (G, E, D, respectively) of the cryptosystem is over a finite cyclic group of order p, and we fix Zₚ=(0, . . . , p−1). When a business 30 first joins the system 10 it gets a secret key sk from the server 12, which is shared with other businesses 30. This key is simply a random element of Zₚ\{0} for the Elgamal cryptosystem instance. The corresponding public key pk is known to the LBS provider server 12, and pre-configured on the program running on the mobile device 22 of users 20. In addition, we assume a secure hash function H(•) and a block cipher (i.e., F(key, •) and F⁻¹(key, •)).

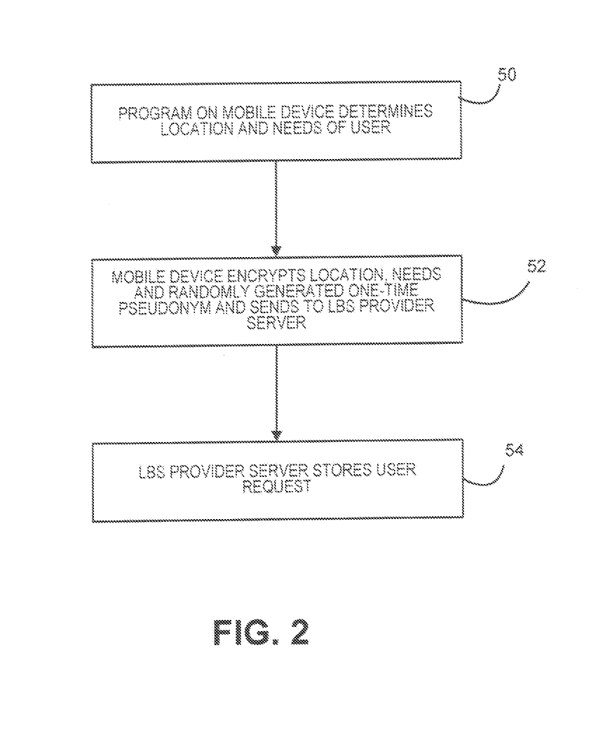

FIG. 2 is a flowchart illustrating operation of the system of FIG. 1 according to embodiments of the present invention. Specifically FIG. 2 illustrates the steps performed for a user 20 to submit a request for a location-based service, e.g., coupon, advertisements, brochures, information, etc. In step 50, the location and/or need of the user 20 is determined as described above. In step 53, the program running on the mobile device 22 uses the public key pk and E to encrypt the user's grid index or grid number i, the m≧0 keyword(s) describing the need (e.g., w₁, . . . , wₘ), and a randomly generated one-time pseudonym ρ. Since the grid number i will be compared privately with the grid number of a business's location of interest, it is encrypted separately from the needs and pseudonym, i.e., (E(pk, i), E(pk, ρ), F(H(i∥ρ), w₁, . . . , wₘ). The symbol “∥” denotes concatenation. The mobile device 22 sends this user request to the LBS provider server 12. In step 54, the LBS provider server 22 stores the received user request in the database 14 as part of a user request database. Because the user's location and needs are encrypted, the LBS provider server 12 is unable to determine them, thus maintaining the user's privacy.

A business 30 may be interested in providing any user 20 in their location of interest (i.e., target location) with an offer, may only desire to make offers to users with a matching need, or may simply want to sample the number of users in a target location to determine what offers to make. A business 30 identifies a central grid j for the location to target and establishes a radius that will include all grids that intersect a circle of that radius having its center at the initial grid. Similarly, a target location may consist of grids forming any shape and the grids may be non-contiguous. Any user 20 within this set of grids that has previously sent a user request to the LBS provider server 12 that is stored in the database 14 are prospects.

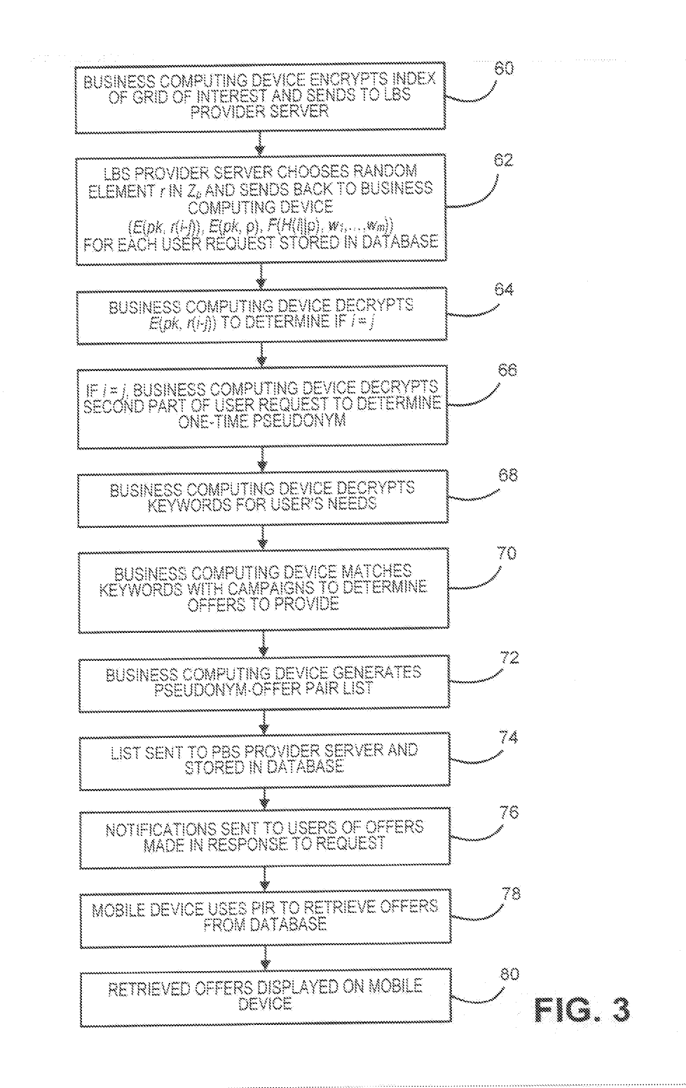

FIG. 3 is a flowchart illustrating further operation of the system of FIG. 1 according to embodiments of the present invention. Specifically FIG. 3 illustrates the steps performed for a business 30 to provide a location-based service, e.g., coupon, advertisements, brochures, information, etc. to a user request that is stored in the database 14 of LBS server 12. In step 60, the computing device 32 of a business 30 uses the public key pk to encrypt the index j of the grid of interest E(pk, j) and sends it to the LBS provider server 12. In step 62, the LBS provider server 12 chooses a random element r in Zₚ and sends back to the business computing device 32 the following: (E(pk, r(i−j)), E(pk, ρ), F(H(i∥ρ), w₁, . . . , wₘ)) for each user request that is stored in database 14. The LBS provider server 12 is able to compute E(pk, r(i−j)) from E(pk, i), E(pk, j), and r because of the additive homomorphic property of the cryptosystem. In step 64, on receipt of the returned information from the server 12, the business computing device 32 uses the secret key sk to decrypt E(pk, r(i−j)) to determine if i=j, that is, if a user 20 is currently in the same grid of interest that the business wants to target. Thus, when the result is 0, this means that i=j and the business can learn that a user is in its grid of interest, but the business does not learn any information about the user or any information about i (the location of a user) if i≠j (i.e., result is a random number). If indeed i=j, then in step 66 the computing device 32 can proceed to decrypt the second part of the response E(pk, ρ) to learn the one-time pseudonym ρ associated with the request for which i=j. In step 68, the computing device will then use this and the matching location j to decrypt the keywords describing the user's needs (i.e., F⁻¹(H(j∥ρ), w₁, . . . , wₘ)). In step 70, the computing device 32 can then match the keywords for the needs (i.e., w₁, . . . , wₘ) with its campaign to determine what offer to give to the user with that pseudonym. If no need is found in a request (i.e., m=0), then the business assumes the user with the pseudonym can be targeted with any offer. Thus, a business will only be able to learn that some user having specific needs is located in its grid of interest, but will not learn any specific information about the users, thereby protecting the user's privacy.

After matching available requests with the campaign and/or after finding a reasonable number of matches in step 70, then in step 72 the business computing device 32 generates pseudonym-offer pairs (ρ,θ). Optionally, this list of pseudonym-offer pairs can be permuted to make linking it with the request database nontrivial. This prevents anyone from linking any observed pseudonyms-offer pair with a specific user request. In step 74, the business computing device 32 sends the list (ρ,θ) to the LBS provider server 12, which stores it in database 14 as part of an offer database. In step 76, the LBS provider server 12 may optionally provide a notification to the programs running on user mobile devices 22 that a business 30 may have made an offer in response to their earlier requests. The LBS provider server 12 is able to probabilistically determine which user 20 to notify because it knows which users made entries to its user request database and it is aware of offers being made by a business 30 to its offer database. Note that the LBS prodder server 12 cannot learn any information without user requests or the offers made that are stored in the database 14. There might be false positives because a user's location and/or need may have failed the business matching process. A user may also opt not to receive any notification, to receive not only for businesses they have previously setup with the LBS provider as businesses of interest, or simply to receive every notification. The user, business and/or LBS provider may associate expiration dates with each user request and business offer, so that the LBS provider server 12 will automatically remove expired user requests and business offers from the database 14.

In step 78, the program running on users' mobile devices 22 would subsequently leverage keyword-based private information retrieval (PIR) queries to retrieve business offers associated with the random pseudonym ρ from the database 14 of the LBS provider server 12. Note that with PIR, the program is able to retrieve the business offers associated with the pseudonym without the LBS provider or any other third parties being able to learn any information about which pseudonym was used in the PIR query and which particular offer was retrieved. Since the response time of PIR queries is linear in relation to the size of the database, users may provide the LBS provider server 12 with date ranges of offers to query to improve performance. Users who consider the disclosure of business names as non-confidential may equally use such to reduce the amount of processing done by the PIR server. In step 80, the business offers retrieved from the database 14 can be displayed to the user 20 on the mobile device 22.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for a location based service provider to provide a location based service offered by a business to a user having a user mobile device comprising:
receiving, by a server associated with the location based service provider, a request for a location based service from the user mobile device, the request being encrypted (E) using a public key (pk) of a homomorphic cryptosystem, the request including an index i associated with the user's location E(pk, i), a description of the user's needs, and a pseudonym for the user;
storing, by the server, the encrypted request in a database;
receiving, by the server from a computing device associated with the business, an index j associated with a location in which the business will offer a location based service, the index j encrypted using the public key E(pk, j);
computing, by the server using a random element r, E(pk, r(i−j), for each encrypted request stored in the database;
sending, by the server, E(pk, r(i−j), the description of the user's needs, and the pseudonym for the user for each encrypted request stored in the database to a computing device associated with the business;
receiving, by the server from the business computing device, a list of pseudonym-offer pairs, the list of pseudonym-offer pairs being generated by the business computing device by decrypting E(pk, r(i−j) for each encrypted request received from the server using a secret key associated with the public key, wherein a user is determined to be located in the location in which the business will offer a location based service (i−j) when a result of the decryption is 0, decrypting the pseudonym for the user and the description of the user's needs included in the encrypted requests in which the user is located in the location in which the business will offer a location based service, matching at least one marketing campaign for the business with the user's needs to determine an offer to provide, and generating, the list of pseudonym-offer pairs from the determined offers to provide; and
storing, by the server in the database, the list of pseudonym-offer pairs for providing to the user.

2. The method of claim 1, further comprising:
receiving, by the server, a private information retrieval query from the user mobile device to retrieve offers associated with the user's pseudonym that are stored in the list of pseudonym-offer pairs stored in the database.

3. The method of claim 1, further comprising:
sending, by the server, a notification to the user mobile device that a business has provided an offer in response to the request for a location based service made by the user.
